(19) United States
(12) Patent Application Publication
(10) Pub. No.: US 2014/0257959 A1
(43) Pub. Date: Sep. 11, 2014

(54) SYSTEMS AND METHODS FOR VERIFICATION OF CONSUMPTION OF PRODUCT

(71) Applicant: Alan L. Chung, San Francisco, CA (US)

(72) Inventor: Alan L. Chung, San Francisco, CA (US)

(21) Appl. No.: 13/793,111

(22) Filed: Mar. 11, 2013

(51) Int. Cl. G06Q 30/02

(52) U.S. Cl. CPC G06Q 30/0226
USPC 705/14.27

(57) ABSTRACT

The present solution provides a new tool for digitally verifying the use or consumption of a product. The methods and systems disclosed herein allow a consumer to easily verify their purchase of a product without removing a product identifier, such as a universal product code (UPC), from the product packaging and mailing it back to the manufacturer. Using the methods and systems disclosed a user can capture an image or a video of a product being, among other actions, opened. The system then analyzes the image or video to automatically verify the product that was consumed and also verifies that the video or image has not been previously submitted to the system. The system can then provide the manufacturer, or other loyalty system, with a product identification and verification the product was consumed.

### FIELD

The present disclosure is directed to systems and methods for implementing a loyalty program based on consumption of goods. In particular, the systems and methods of more efficiently and automating the identification and verification of consumption of goods.

### BACKGROUND

A loyalty program can be a powerful marketing tool used by large and small business from airlines, to your corner café. However, loyalty programs are not widely used by product manufacturers and Consumer Packaged Goods (CPG) companies. The few attempts to build a loyalty program for packaged goods have met with limited success because existing implementations are expensive for manufacturers to operate and inconvenient for consumers to use.

For example, cereal manufacturers ran reward programs where consumers needed to cut out and collect a number of Universal Product Codes (UPC) codes from the cereal box and mail them in to exchange for rewards. Few people took the trouble to cut out the UPC codes and mail them back to the manufacturers for their reward. And for the manufacturers it was expensive to handle the mailed in UPC codes. Even today the process is only a little better with the aid of the Internet and better printing technology. The current state of the art in manufacturer loyalty program is custom printed unique codes inside each product that consumers have to enter manually at a website. Entering each code by hand is even more inconvenient than cutting out a UPC code. The requirement of printing a unique code inside each product means only the largest manufacturers can afford the significant investment in printing equipment across multiple factories.

### BRIEF SUMMARY

To address these problems, the present solution implements an innovative process, leveraging modern computing devices with an attached camera such as a smart phone, that makes it possible to run a product loyalty program without custom printing. The present solution provides a way that consumers can easily prove to the manufacturer they have purchased the required number of products to claim their rewards. The act of cutting out and mailing in the UPC code was to ensure that UPC code is destroyed and cannot be reused. This is also true for entering the unique code inside the product box on a website. Once entered, that code cannot be reused. The process of the present solution is sometimes referred to as ‘Scan And Stomp’. A verification application running on a computing device with a camera captures a short video of the UPC code being destroyed. For example, a consumer can use the verification application to capture the UPC code on a soft drink can, and then capturing the can being flattened, thus ensuring it can't be reused for the loyalty program. UPC codes from different products can be “destroyed” in many different ways. Cardboard box UPC codes can be cut in half, or marked with a pen. Glass bottle's label with the UPC code can be torn off. The short video taken and sent to the verification server is easy to verify using various techniques such as computer vision or human inspectors.

Another great improvement of the product loyalty technology of the present solution is the ability work with any product using the same verification application. That is not possible with previous technique of custom printed unique codes, because those codes are only unique for one product. The codes cannot easily be unique across all possible products present and future. Which means consumers have to go to a specific websites for each product to enter the codes. In contrast, consumers can use the same verification application to capture the destruction of UPC codes on a Brand A soft drink soda can, a Brand B cereal box label and a Brand C glass bottle. The UPC code is unique and will identify which product's loyalty program the consumer should be credited.

In some aspects, the present solution provides a new tool for digitally verifying the use or consumption of a product. The methods and systems disclosed herein allow a consumer to easily verify their purchase of a product without removing a product identifier, such as a universal product code (UPC), from the product packaging and mailing it back to the manufacturer. Using the methods and systems disclosed a user can capture an image or a video of a product being, among other actions, opened. The system then analyzes the image or video to automatically verify the product that was consumed and also verifies that the video or image has not been previously submitted to the system. The system can then provide the manufacture, or other loyalty system, with a product identification and verification the product was consumed.

According to one aspect, the present solution is directed to a method for verifying consumer consumption of a product includes receiving, by a server, a media file from a device of a consumer. The media file includes a representation of a product and a representation of the product being consumed. The method also includes identifying, via the server, the product represented in the media file, and verifying, via the server, that the product has been consumed. Finally, the method includes providing, by the server, a product identifier and verification data associated with the consumer.

In some implementations, the method includes determining if the representation of the product in the media file includes one or more features of the product that uniquely identifies the product. In certain implementations, verifying the product is consumed includes determining that the representation of the product being consumed in the media file includes one or more features that uniquely identify an act of consumption of the product.

In certain implementations, the media file can be an image, a video or an audio file, and can be associated with a location identifier and/or a time stamp. The representation of the product can includes a barcode, a product logo, a product name, a international standard book number, an universal product code, or a European article number, and the representation of the product being consumed comprises at least one of the product being opened, unwrapped, cut, crushed, marked with a writing instrument or a portion of the product crossed out with the writing instrument.

In other implementations, the method also includes comparing the representation of the product in the media file to a stored representation of the product on the server. In some implementations, the product in the media file and the consumption of the product in the media file is identified via a computer vision system or human operator. The method can also include receiving, by the server responsive to a user's inspection of the media file, identification of the product from the representation of the product or a verification that the product has been consumed from the representation of the product being consumed.

In certain implementations, verifying the representation of the product being consumed is a unique instance includes creating a unique fingerprint of the media file and comparing the unique fingerprint of the media file to a plurality of previously stored fingerprints.

According to another aspect, the present solution is directed to a system for verifying consumer consumption of a product includes a server configured to receive a media file from a device of a consumer. The media file may include a representation of a product and a representation of the product being consumed. The system may have a verification engine configured to identify a product from the media file based on the representation of the product in the media file and verify that the product has been consumed from the representation of the product being consumed in the media file. The server is also configured to provide a product identifier and verification data associated with the consumer.

In some implementations, the server is configured to determine if the representation of the product in the media file includes one or more features of the product that uniquely identifies the product. The server can also be configured to verify the product is consumed by determining that the representation of the product being consumed in the media file includes one or more features that uniquely identify an act of consumption of the product.

In some implementations, the media file includes one of an image, a video or an audio file, and can be associated with a time stamp and/or location identifier. In other implementations, the representation of a product comprises at least one of a barcode, a product logo, a product name, a international standard book number, an universal product code, or a European article number, and the representation of the product being consumed comprises any time and form of use or consumption, such as at least one of the product being opened, unwrapped, cut, crushed, marked with a writing instrument or a portion of the product crossed out with the writing instrument.

In other implementations, the server is configured to identify the product by comparing the representation of the product in the media file to a stored representation of the product on the server. The server can be configured to use a computer vision system on the media file to one of identify the product from the representation of the product or verify that the product has been consumed from the representation of the product being consumed.

In yet other implementations, the server can be configured for a user to inspect the media file to one of identify the product from the representation of the product or verify that the product has been consumed from the representation of the product being consumed. The server can also be configured to create a unique fingerprint of the media file and compare the unique fingerprint of the media file to a plurality of previously stored fingerprints.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device; in accordance with an implementation of the present disclosure;

FIG. 1B is a block diagram depicting a cloud computing environment comprising client device in communication with cloud service providers; in accordance with an implementation of the present disclosure;

FIGS. 1C and 1D are block diagrams depicting embodiments of computing devices useful in connection with the methods and systems described herein;

FIG. 2 is an embodiment of a system comprising server for verifying the use or consumption of a product;

FIGS. 3A-3F is a series of illustrations of example product representations that can be used to verify the use or consumption of a product;

FIG. 4 is a flow chart illustrating an example method for verifying the consumption or use of a product; and

FIGS. 5A and 5B is a snapshot of a view of a mobile application designed and constructed to provide media files for verifications.

### DETAILED DESCRIPTION

For purposes of reading the description of the various embodiments below, the following descriptions of the sections of the specification and their respective contents may be helpful

Section A describes a network environment and computing environment which may be useful for practicing embodiments described herein.

Section B describes embodiments of systems and methods for verifying the use or consumption of a product.

### A. Computing and Network Environment

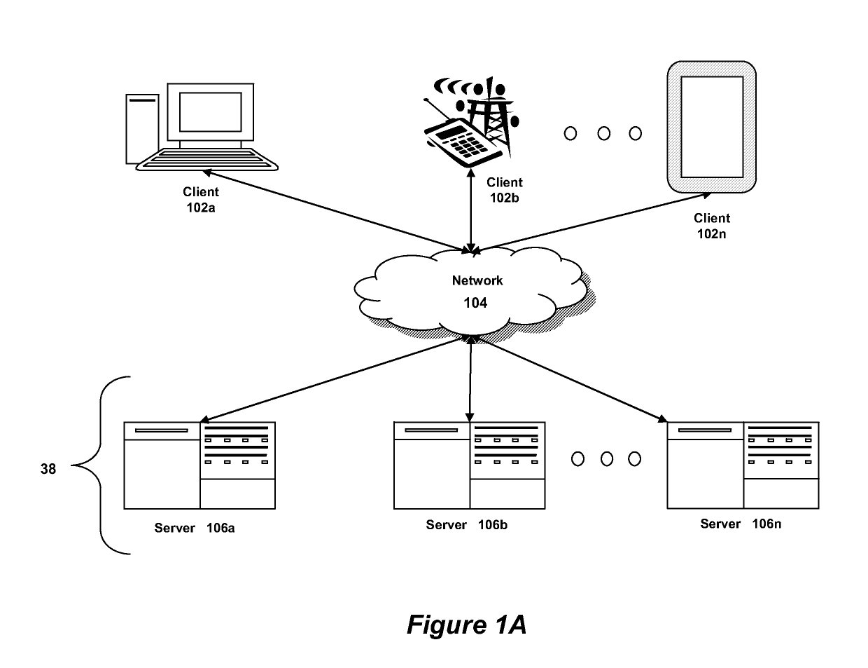

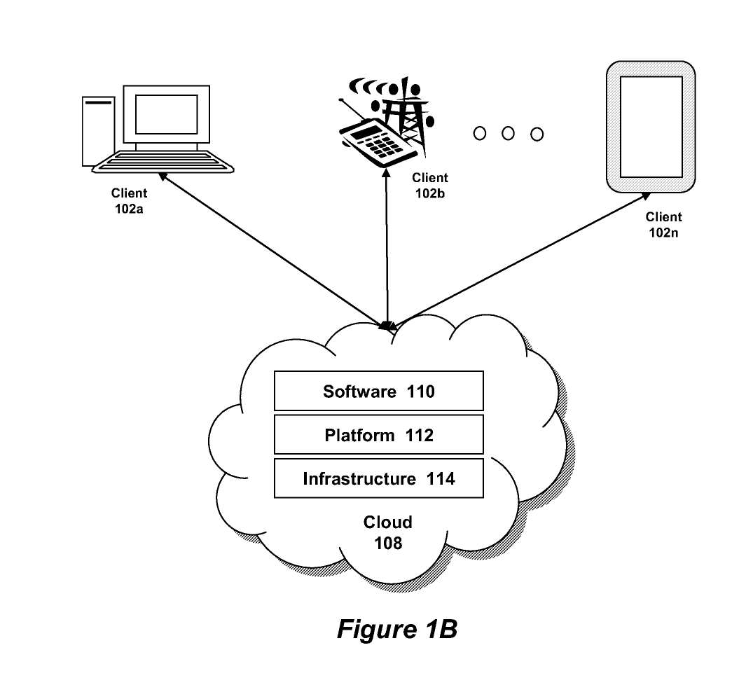

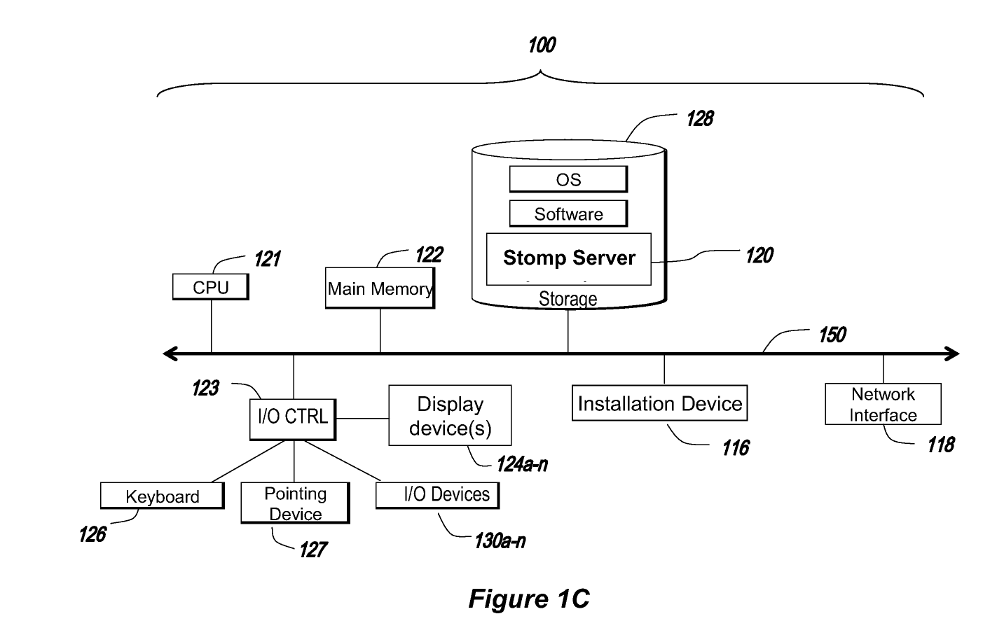

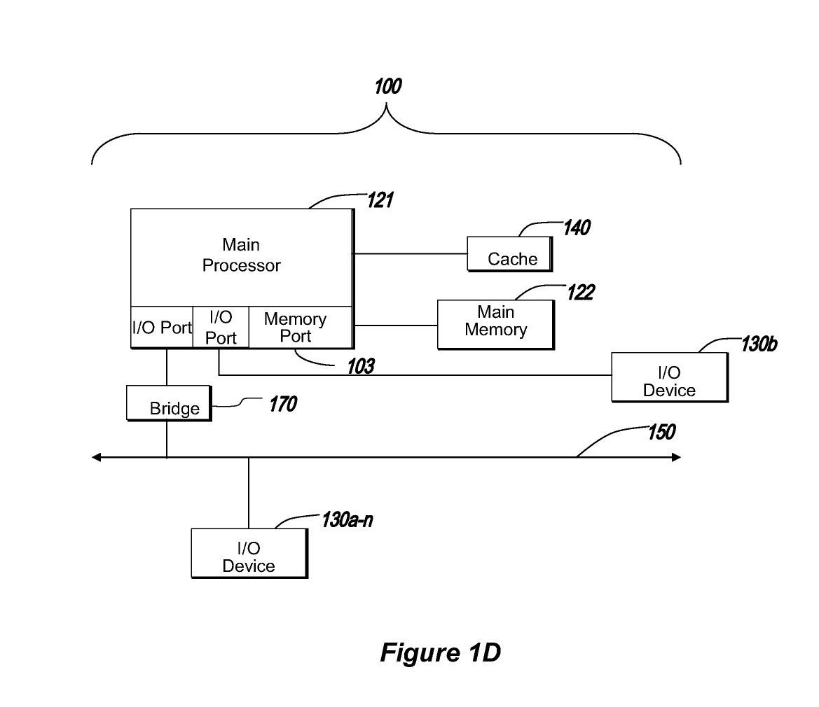

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a stomp server 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for the Verification of Consumer Consumption of Products

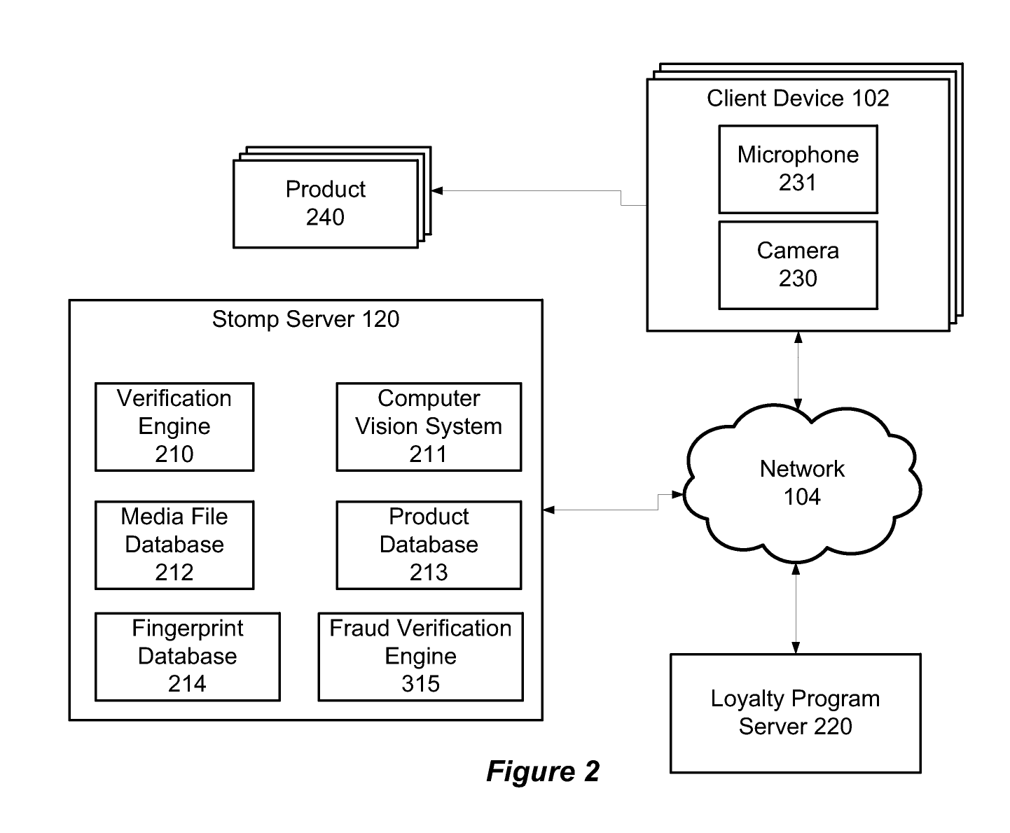

Referring now to FIGS. 2-4, systems and methods of implementing a more efficient loyalty rewards technology via which consumers can easily prove to the manufacturer they have purchased and/or consumed products to claim their rewards are described. The systems and methods of this solution are agnostic to the type and form of product and seamlessly and efficiently works with any product for easy adoption by manufacturers. The present solution has multiple inventive aspects, including but not limited to: (i) techniques to identify a product within media, such as video; (ii) techniques to verify via media, such as video and/or audio, that the product has been consumed, used or destroyed; (iii) ways to efficiently detect fraudulent submissions; and (iv) electronic and automatic determination of rewards or participation in a loyalty program and/or administration of the same based on product and verification data.

Referring now to FIG. 2, a system 200 for verifying the consumer consumption of a product 240 is depicted. The system 200 includes one or more client devices 102, Each client device may further include a camera 230 and a microphone 231. The client device 102 captures media files, such as video, that include representations of the product 240 and representation of the product being consumed. The client device 102 transmits the media file to a stomp server 120 via the network 104. The stomp server may store to a media file database 212. Via the stomp server 120 the product is identified from the media file via use and comparison to product database 213 and/or media file database 212. Via the stomp server, the consumption of the product 240 via the media file is verified, such as via using fingerprints 214 and/or use of the product database and media file databases. The stomp server may provide product identification and verification data to a loyalty program server 220 or otherwise process the same for a loyalty program. The stomp server may include a fraud detection engine 215 for detecting and action on fraudulent or potentially fraudulent media file submissions.

Referring to system 200, and in greater detail, the system 200 includes at least one client device 102. As discussed above in Section A, the client device can be, but is not limited to, a smart phone, tablet computer, laptop, or a computer. The client device 120 can include a microphone 231 and a camera 230. In some implementations, the camera 230 is configured to record video and/or still images. In some implementations, the camera 230 can be the camera of a smart phone or the video messaging camera found in the bezel of a laptop. The microphone 230 can be microphone of a smart phone or an audio input of a computer.

In some implementations, a user uses the client device 102 to capture media files of a product and the product 240 being consumed. The media file can include video, still images and/or audio. For example, in one implementation, the media file might include an image of a candy bar before and after the candy bar has been opened. In another example, the user may only be required to take a picture of the product after the product has been opened. In yet other implementations, the media file may include a video of the user consuming the product.

As described above, the media file can also include audio signals from the client device's microphone 231. In some implementations, the audio file can be the sole source component of the media file, such that the verification the product was consumed is determined only on the audio file. In other implementations, the audio file can be a component of the media file and is used in combination with another media format, such as video, to identify the product and verify the product 240 was consumed. Audio used in the verification of a product's consumption can include the sound of the product being opened or consumed. For example, the user may record a video, with sound, or a soda can being opened. In other implementations, the audio file contains background noise that, as discussed below, is used to create a unique fingerprint for each media file.

In some implementations, the media files can be captured with the default, pre-installed software on the client device 102. For example, a user may use the built in camera function and software of the user's smart phone to capture the media file. Responsive to capturing the media file, the user can upload the media file to the stomp server 120. In another implementations, the stomp server 120 may only accept media files captures with software distributed by the stomp server 120. For example, the stomp server 120 may make available a smart phone application, which a user can download and install on their smart phone. Using the software, the user can capture the media file of the product being consumed. Response to capturing the media file, the stomp server phone application can automatically upload the media file to the stomp server 120.

There is no restriction on the type of product the stomp server 120 can identify and/or verify was consumed. In some implementations, the products can include consumable products (e.g. products that can be used up, destroyed, or dissipated) such as, but not limited to, food items, household goods, and office supplies. In other implementations, the products can include capital or durable goods, such as, but not limited to, electronic devices, furniture, clothing. For a capital or durable good, the consumption of the good may include taking ownership of the good. For consumable goods, the consumption of the good can be indicated by, but is not limited to, one of the product 240 being opened, unwrapped, cut, crushed, marked with a writing instrument or a portion of the product or identifier being crossed out with the writing instrument, a tab being opened, a wrapper being torn, cut or open, a foil top being pulled open video of a soda can tab being popped open.

The systems and methods of the present solution herein may be implemented and designed, constructed and/or configured for verification of different products with different options for verification based on the ways consumers consume, use or may otherwise mark, destroy or indicate that the product has been purchased, is owned or otherwise is a particular and unique instance of the product. The verification may be based on the particular attributes or characteristics of the product and how the product may be consumed, including but not limited to the video and/or audio characteristics of consumption of the product.

The systems and methods of the present solution herein may be implemented and designed, constructed and/or configured to identify products based on any attributes or characteristics of the product including visual and/or audio related characteristics of the product. A product may be identified by one or more visual marks, logos, colors, etc. on the product and/or the packaging of the product. A product may be identified by any text and/or numbering on the product and/or packaging of the product, such as manufacturer's name or a brand name or product name or product numbers and/or serial numbers. A product may be identified by any computer generated coding such as bar codes. A product may be identified by size, shape and color of the product and/or packaging.

A product 240 may be identified by one or more identifiers or combination of identifiers. An identifier can include a barcode, a product logo, a product name, a international standard book number, an universal product code, or a European article number. In some implementations, the identifier is unique to each unit of a product 240, and in other implementations, the identifier is unique only to the product 240. Take for example a laptop of a specific product line manufactured by a specific manufacturer. In this example, each unit produced, e.g., each laptop, has a unique serial number, which can be used as a product identifier. In this example, the laptop's universal product code is shared with each laptop of the same product line. In implementations that use a product identifier that is unique to a product line but not a specific product item within the line, the system 200 can correlate the destruction where the product identifier is unique to the product but may not be unique to each individual item of the product, the product identifier must be destroyed to ensure that it is not resent to the stomp server 120.

Now referring to the stomp server 120 in greater detail. The stomp server 120 can include a plurality of components and sub-components. In some implementations, the sub-components are housed within a single entity, such as a server, and in other implementations, the components and sub-components can be distributed throughout a plurality of entities, such as the servers of a server farm. The stomp server and any components and sub-components of the stomp server can include an application, program, library, script, service, task or any type and form of executable instructions executable on one or more devices, such as servers.

The stomp server 120 can include a verification engine 210. The verification engine is designed, constructed and/or configure to identify products from a media file and verify consumption of the product via the media file. As a media file can have a video and/or audio representation of a product, the verification engine may be implemented to identify a product from the video and/or audio representation. As a media file can have a video and/or audio representation of a product being destroyed, consumed or used, the verification engine may be implemented to verify the destruction, consumption or use of the product from the video and/or audio representation.

The stomp server and/or verification engine may be designed and constructed to receive a multitude of media files in different formats and sizes via different communication protocols. For example, the stomp server may have an interface for users to upload media files via a user interface of the stomp server. The stomp server may have a SMS or MMS interface for users to share, send or transmit media files to a predetermined SMS or MMS address associated with and processed by the stomp server. The stomp server may have an email interface for users to share, send or transmit media files to a predetermined SMS or MMS address of the stomp server. The stomp server may have a corresponding application or app for a mobile device, such as smartphone or tablet, that provides an interface for a user to create and/or send media files to the stomp server. The stomp server may interface with and/or provide an application for interface with any type and form of social networking site via which users at the social networking site may identify and transmit media files to the stomp server.

Responsive to receiving a media file, the verification engine 210 may identify the product in the media file and the consumption of the product in the media file. The verification engine may determine the user or consumer associated with the media file based on the source of the media file and/or attributes or meta-data of the media file. The verification engine may determine the user or consumer associated with the media file based on the account of the user at the stomp server under which the media file was submitted. The verification engine may determine the time of submission of the media file based on the media file, meta-data of the media file, or network communications regarding the same. The verification engine may determine the location or geography from which the media file was submitted based on the media file, meta-data of the media file, or network communications regarding the same. The verification engine may receive and identify global positioning satellite (GPS) information from a device, such as a mobile device, from which the media file was created or submitted. The verification engine may receive and identify accelerometer information from a device, such as a mobile device, from which the media file was created or submitted.

The stomp server may use a plurality of databases for implementation, such as a media file database 212, product database 213 and fingerprint database 214. These databases may comprise any type and form of database, such as relational or object databases.

The stomp server may store media files, such as media files received from a consumer, to the media database 212. The media database may comprise any type and form of database, such as relational or object database. The media database may comprise a database designed and constructed for storing and managing media files. The media database may store media files in associated with each user or consumer, such as users with an account maintained by the stomp server. The media database may store any geographical and/or temporal information about the media file. The media database may track and maintain a history of media file submissions from a user. The media database may track and maintain a history of media file submissions based on product, manufacturer and/or loyalty or rewards program.

The media file database may store representative or example media files that have suitable or acceptable representations of a product and/or destruction, consumption and/or use of the product. These media files may be provided by the stomp server to users for educational or instructional purposes. Each loyalty or reward program or manufacturer may have a set of media files stored in the media file database which provide a standard or guidelines or parameters for identifying their product and/or consumption of the product. The stomp server and/or verification engine may uses these media files for identification and/or verification purposes. For example, a human operator reviewing the received media files from a consumer may compare the received media file to the representative media file of the manufacturer, such as in a side by side comparison, to assist in the identification of the product and/or consumption of the product and/or meeting the identification and/or verification guidelines and/or desired level of quality control.

The product database 213 may store information on the products supported by the stomp server. The product database may store data on product names, product identifiers, manufacturer information and loyalty program. The product database may store data on identification and/or verification requirements, guidelines or parameters. The product database may store data on type and form of identification and/or verification data for product and/or manufacturer. The product database may store data on type and form of identification and/or verification data required for or used by the loyalty or rewards program. The product database may link to or include media files in the media file database that are representations of the product identifiers and/or product consumption to be used for identification and/or verification for that product. The product database may link to or include fingerprints from the fingerprint database representation of the product identifiers and/or product consumption to be used for identification and/or verification for that product.

The fingerprint database 214 may comprise any type and form of fingerprints that uniquely identify a product in a media file and/or the consumption, use or destruction of the product in the media file. The fingerprint may be an audio based fingerprint. The fingerprint may be a video or image based fingerprint. The fingerprints may use any type and form of algorithm that generates a unique pattern, indicator or value from characteristics of the media file that is suitable for identification and/or verification of product as described herein. Each product, manufacturer and/or loyalty program may have one or more fingerprints that if matched within a certain threshold indicate the product has been identified within the media file. Each product, manufacturer and/or loyalty program may have one or more fingerprints that if matched within a certain threshold indicate the product has been identified within the media file. The verification engine may compute and store to the fingerprint database fingerprints of each media file submission, such as to be used for fraud prevention or otherwise identifying redundant or duplicate submissions.

The verification engine may identify product and/or consumption of product by automated means, such as computer vision system or with assistance or use of operators who visually inspect media files. In some implementations, the verification engine may use a combination of automated means with operator assistance or operator supplemental input. The verification engine may use any combination of the media file database, product database and fingerprint database to perform the identification and/or verification by automation and/or operator.

Identification of a product from a media file can be based on comparison of the representation of the product in the media file to the product database, media file database or the fingerprint database. A product identifier in the product representation in the media file can be compared to product information in the product database. The portion of the media file showing the representation of the product can be compared to a corresponding representation of the product stored in the media file database. Identification of the product from the media file can be performed by comparing a fingerprint of the media file or portion thereof having the representation of the product to a fingerprint in the fingerprint database.

Verification of consumption of a product from a media file can be based on comparison of the representation of the product being consumed in the media file to the product database, media file database or the fingerprint database. A representation of act of consumption or result of consumption in the media file can be compared to product information in the product database. The portion of the media file showing the representation of act of consumption or result of consumption in the media file can be compared to a corresponding representation of the act of consumption or result of consumption in the media filet stored in the media file database. Verification of consumption the product from the media file can be performed by comparing a fingerprint of the media file or portion thereof having the representation of the act of consumption or result of consumption to a fingerprint in the fingerprint database.

The verification engine may be designed, constructed and/or configured to provide a user interface for operators to review media files and perform identification and consumption of product from the media files. The user interface of the verification engine may provide side by side comparisons to a submitted media file with one or more acceptable product identification information or representative media files. The user interface may provide an interface for the operator to select or input the found product identifier and/or to describe or identify the consumption of the product or indicate or confirm verification of the same.

The stomp server 120 and/or verification engine can also include, integrate with and/or interface or communicate with a computer vision system 211. The computer vision system 211 may comprise software, hardware or any combination of software and hardware designed and constructed to visually, digitally or electronically inspect video and images to discern, detect, identify and provide one or more unique or other desired characteristics. The computer vision system may comprise an optical character recognition for recognizing text and other data from a visual or display content of the media file. The computer vision system may be implemented, designed, constructed and/or configured to specifically identify product identifies in the media file and/or consumption, destruction or use of the product via the media file.

In operation and responsive to receipt of a media file, the verification engine determines if the media file includes an authentic representation of the product being consumed. In some implementations, the verification engine 210 can determine if the media file contains a representation of a product being consumed. For example, the verification engine 210 can determine that the video uploaded is of a user's TV, which is playing a commercial that shows the product 240 being opened. In this example, the verification engine 210 could determine the video of the product 240 being consumed in a TV commercial and not an authentic representation of the product being consumed.

Using the fingerprint database 214 discussed below, the verification engine 210 can also determine if the media file contains a unique representation of the product 240 being consumed. For example, the verification engine 210 can determine if a media file has been submitted more than once for the consumption of a single product 240. In another implementation, the verification engine 210 can determine if the user is uploading one of multiple media files of the same product 240 being consumed. For example, a consumer and the consumer's friend may both capture a video of the opening of the same bottle of soda. In this example, the verification engine 210 can determine the video are of the same bottle and may not authenticate the second submission. The verification engine 210 may analyze background noise in the media file to determine the two media files were captured at relatively the same time and/or location. In other implementations, the client device 102 location and/or a time at the capture of the media file may be included with the media file. In such an implementation, if two media files are received by the stomp server 120 at the same time and originated from the same location, the stomp server 120 may determine the media files could be treated as the representation of a single product being consumed. In certain implementations, the media files are authenticated as unique by comparing a fingerprint of the media file to the fingerprint of previously received media files. For example, after receipt a hash may be generated for each media file. The hash can then be compared to the previously stored hashes in the fingerprint database 214 to determine the uniqueness of a media file. In other implementations, the verification engine 210 may determine the uniqueness of the consumption by comparing the media file to media files previously stored in the media file database 212.

The computer vision system 211 can analyze the media file to determine what product 240 is being consumed by identifying a product identifier in the media file. For example, the product identifier can be least at least one of a barcode, a product logo, a product name, a international standard book number, an universal product code, or a European article number in the media file. Via the computer visions system a barcode (UPC, EAN which is Europe's UPC equivalent, ISBN, etc) may be scanned. The computer visions system may also can other identifiable marks on the product (logos, product name using OCR, etc).

Responsive to identifying a product identifier, the computer vision system 211 can look up the product 240 in the product database 213 by the product identifier. For example, the media file may contain a bar code, which the computer vision system 211 identifies. Using the barcode, the computer vision system 211 may retrieve the book's title, manufacture and/or other information from the product database.

In certain implementations, the computer vision system 211 may be replaced or supplemented by human inspection of the media file. For example, the stomp server 120 may receive a video of a product being consumed. The stomp server 120 can display the video to a human inspector, such that the inspector views the media file to identify the product 240 and verify its authenticity. In other implementations, the verification engine 210 can assign a confidence ranking to at least one of the product identification and the authenticity the consumption is of a unique product 240. In these implementations if the confidence ranking is below a predetermined threshold, the verification engine 210 can ask the inspector for a second opinion. For example, the verification engine 210 may ask for assistance if the verification engine 210 is 75% sure the media file contains a new image of a product being consumed. The verification engine 210 can also ask for inspector assistance if part of the representation of the product is obfuscated. For example, if the media file only contained half of a bar code. In certain implementations, the media files are stored in a media file database 212 for later verification or re-verification. In yet other implementations, media files with a confidence ranking below the predetermined threshold are saved in the media file database 212, and may be re-verified at a later data if requested.

The stomp server may include a fraud prevention or detection engine 315. The fraud detection engine may be designed, constructed and/or configured to detect fraudulent activity or submissions of media files. The fraud detection engine may detect if the same user has submitted the same media file more than once. The fraud detection engine may detect if multiple users have submitted the same media file. The fraud detection engine may detect if a media file has been manipulated or altered in a way to disguise or re-use a previous submission. The fraud detection engine may compare fingerprints of each received submission with previous submissions to determine if there any potential duplicate submissions of the same user or across all users. The fraud detection engine may use fingerprinting techniques and/or the computer vision system to detect such fraudulent activity.

The fraud detection engine may be designed, constructed and/or configured to detect the authenticity of a representation of the product and/or consumption of the product, such as media file submissions showing fake representations of the product and/or consumption of the product. use audio fingerprinting to determine if the sound in the media file related to the product is authentic. One possibility might be a recording of the sound of the product being opened. For example, the sound of a soda opening, with the background sounds may be unique enough to use a fingerprint for each submission. In some implementations, the consumer may hold the phone next to the can when they pop it open and this sound plus the accelerometer data may be unique enough for a fingerprint.

The fraud detection engine may use any combination of network information, source device or application information, user information, temporal, geography, meta-data and fingerprints of the media file, to determine if a submission may be fraudulent. The fraud detection engine may determine the frequency of submissions from the same user, device, location against any thresholds on the same to detect potentially fraudulent activity. The fraud detection engine may analyze patterns across submissions to determine any patterns that indicate fraudulent activity.

Responsive to detecting potential fraud, the fraud detection engine may flag the submission for further review or inspection, such as by a human operator. Responsive to detecting fraud or potential fraud, the fraud detection engine may provide a notice or indicator to the verification engine so as not to verify this submission, such as for a loyalty or rewards program.

The stomp server and/or verification engine generates, provides and/or stores product identification and verification data for each media file submission. The product identification data may comprise the product identifier that was identified via the media file submission and/or any corresponding data from the product database. The identification data may comprise the type or form of identification and/or the time and date of identification. The verification data may comprise the type or form of consumption, the type or form of verification of the consumption and/or time and location of consumption. The identification and verification data may include contact information or identifying information of the user. The identification and verification data may include location, geographic information on the media file submission or submitter.

Now referring to the loyalty program server 220 depicted in system 200. As discussed above, companies, such as manufacturers, may offer reward or other promotions responsive to a user purchasing their products. For example, a company may offer a loyalty program, such that a customer is rewarded with a free soda after the purchase of ten sodas. The loyalty program server 220 can be responsible for the administration of the loyalty or rewards program and/or the distribution of the rewards and other promotions. As illustrated the loyalty program server 220 is separate from the stomp server 120, but in other implementations the loyalty program server 220 can be a sub-component of the stomp server 120. In certain implementations, the stomp server 120 may have an API that allows the loyalty program server 220 to communicate with the stomp server 120.

The stomp server may communicate to the loyalty server and/or the loyalty server may obtain or receive from the stomp server identification and verification data. The identification and verification data may be sent on a real-time basis as each media file submission is verified. The identification and verification data may be sent on a predetermined frequency and/or batch basis, such as every day at a predetermined time and/or when a predetermined number of submissions are processed. The loyalty server may use the identification and verification data to process the submission by the consumer to a corresponding loyalty program and/to register or provide any corresponding rewards, points or promotions. Likewise, the stomp server may include or provide the loyalty program, and may process and administer the loyalty program using the identification and verification data.

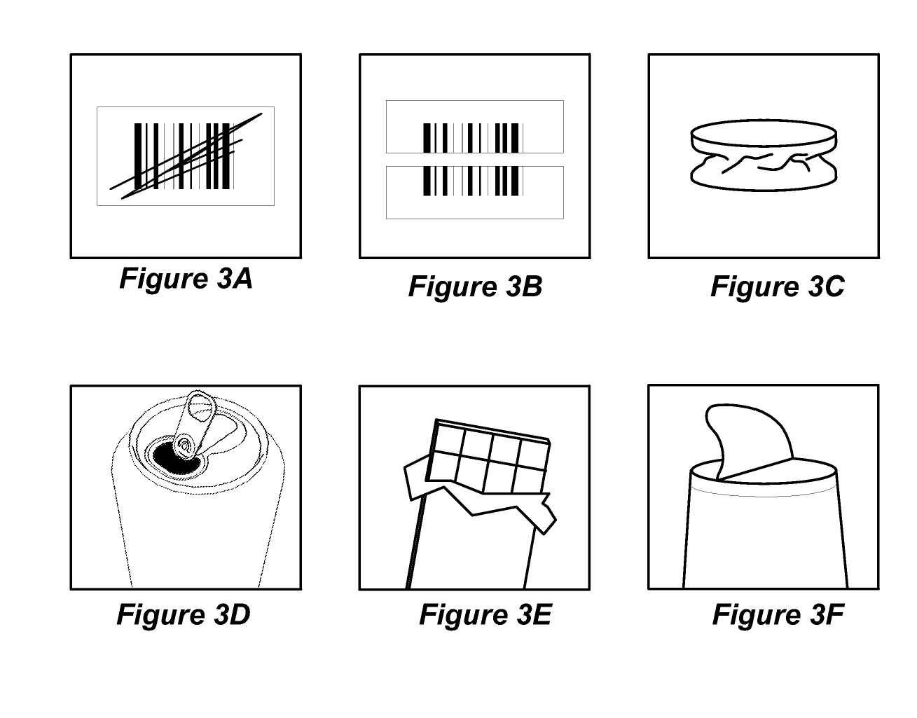

FIGS. 3A-3F is a series of images that illustrate possible representations of a product 240 being consumed. The illustrations of FIGS. 3A-3F are provided as example representations of a product 240 being consumed and are not meant to limit the scope of the disclosure. In some implementations, the consumption of a product can refer to the unwrapping, opening, or other action that makes the product un-returnable for a refund at the place of its purchase. For example, a candy bar can be considered consumed upon opening its wrapper.

FIGS. 3A and 3B illustrate a universal product code (UPC) 301. In FIG. 3A, the UPC 301 has been marked out to represent consumption of a product. FIG. 3B illustrates, the UPC 301 having been cut in half. In some implementations, the client device 102 will record the actual destruction of the product identifier, and in other implementations, the client device 102 records the product identifier once it has been destroyed. In a similar implementation, the media file can include a video of a UPC 301 being removed from the box in which the product 240 came.

FIG. 3C illustrates a representation of a soda can being crushed. In FIG. 3D, the soda can is verified as consumed by opening the can. In another implementation, the representation of a product being consumed can include the initial unscrewing of a screw top bottle. FIG. 3E illustrates a candy bar being unwrapped and FIG. 3F illustrates a yogurt cup opening.

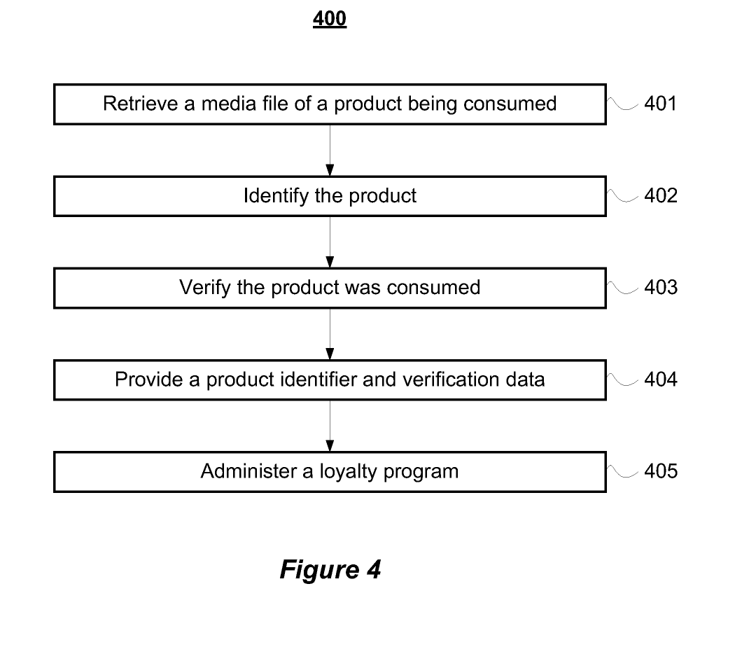

FIG. 4 is a flow chart of an example method 400 for identifying a product and verifying the consumption of the product. The method 400 includes receiving a media file of a product 240 being consumed (step 401). Responsive to receiving the media file, the product 240 in the media file is identified (step 402). The method 400 also includes verifying that the product 240 was consumed (step 403). A product identifier and verification data is then transmitted to a loyalty program server (step 404). Responsive to the receipt of the product identifier and verification data, the loyalty program is administered (step 405).

At step 401, the stomp server receives a media file (step 401). The stomp server may receive the media file from a mobile device of a consumer. The stomp server may receive the media file from an application designed and constructed to work with the stomp server. The media file can include the representation of a product 240 and/or representation of the product being consumed. As discussed above, this can include a picture or a video of the product 240 being opened, used, unwrapped, cut, or a product identifier marked out or destroyed. In some implementations, the media file is received from a client device. In other implementations, the media file may be stored in a database, wherein the receiving step includes retrieving the media file from the database.

At step 402, the product 240 represented in the media file is identified. In some implementations, the product 240 is identified by visual inspection, and in other implementations the product 240 is identified via a computer vision system 211. The identification of the product 240 can be accomplished by identifying the product's packaging. For example, a product can have a distinctive shape and/or logo that the computer vision system 211 can use to identify the product. In other implementations, the product 240 can be identified by a product identifier on the product or product packaging, such as, but not limited to, a barcode, a product logo, a product name, a international standard book number, an universal product code, or a European article number.

At step 403, consumption of the product is verified via the stomp server, such as via the verification engine. As discussed above, in some implementations, the verification ensures that a product's consumption is only authenticated once with the stomp server 120. For example, the stomp server 120 may create a hash of each media file after receipt of the media file. The verification engine 210 can then compare the hash to other hashes to determine if the consumption of the product has ever been authenticated before. In certain implementations, the verification engine 210 also determines if the presentation of the product 240 in the media file is authentic. For example, the verification engine 210 may be able to determine if a client device 102 has submitted a picture of a picture of a product being consumed or an image that has been photographically manipulated.

At step 404, a product identifier and verification data is transmitted to a loyalty program. As discussed above, the product representation in the media file is identified and its consumption verified (not necessarily in that order). This data can be transmitted to a loyalty program server. In some implementations, the data is stored into a database for later retrieval by the loyalty program server.

At step 405, the loyalty program is administered. As discussed above, the disclosed system can be used in conjunction with a customer loyalty program. Administration of the loyalty program may include providing a customer with a monetary reward, points, coupons, or a donation to a charity. For example, a company may offer to donate 5 cents for every can of soda whose consumption was verified through the system 200. In another example, a company may provide a user with a free product upon confirmation they have purchased and/or consumed 10 of the products.

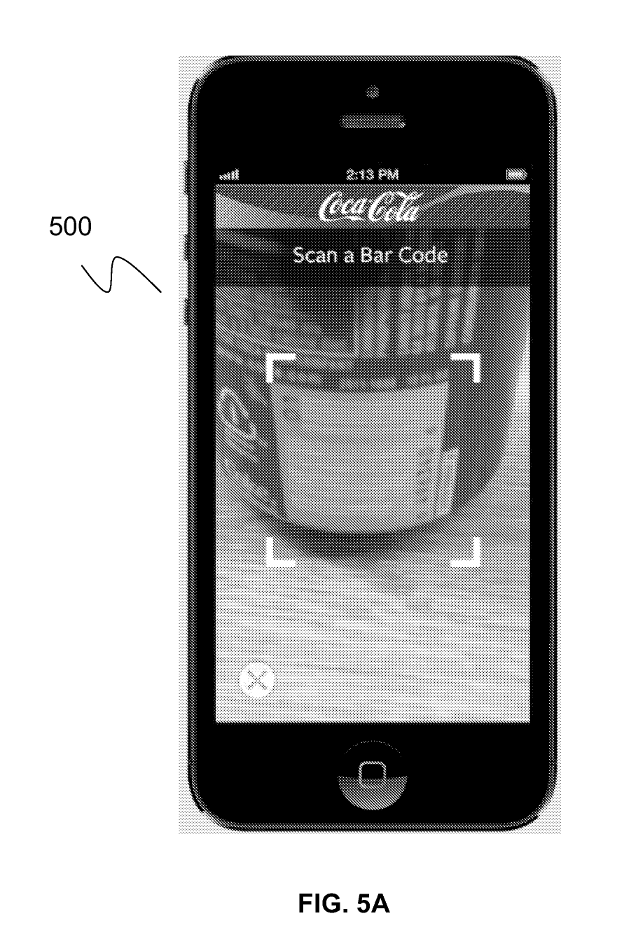

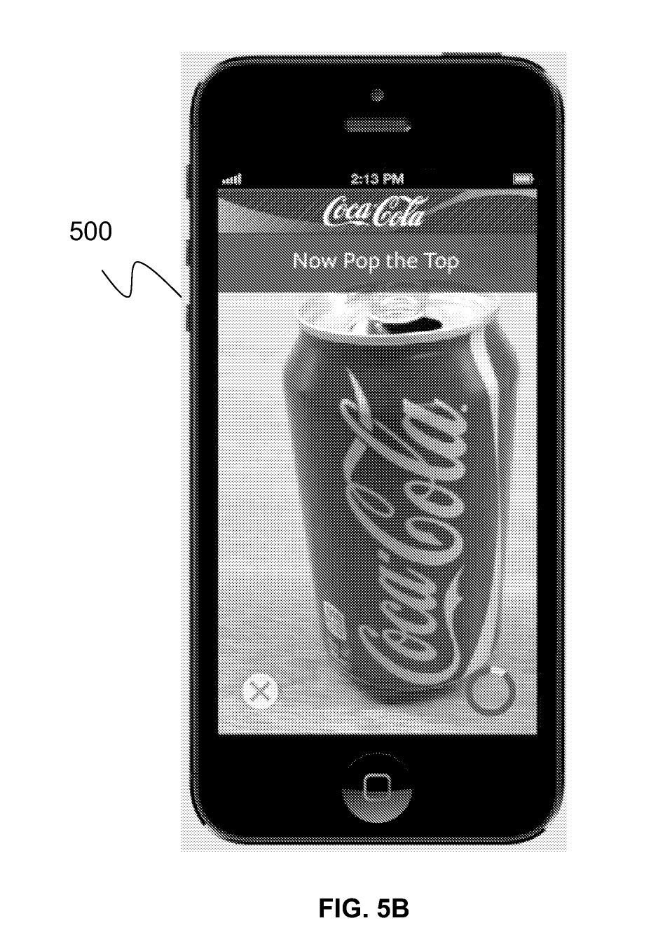

Referring now to FIGS. 5A and 5B, a mobile application 500 designed and constructed to capture media files and send them to the stomp server for verification is depicted. The mobile application may be designed and constructed to capture video and/or audio of a product and communicate the resulting media to the stomp server for verification, such as under an account of the user of the mobile application. The mobile application may receive notification or indication that the stomp server received the media file for processing. The mobile application may receive notification or indication of whether or not the submission was verified, such as in accordance with the corresponding loyalty or rewards program.

Referring to FIG. 5A, an embodiment of a mobile application capturing a product identifier is depicted. The mobile application may be designed and constructed to prompt the user to capture a video of a portion of the product targeted to have the desired product identifier. The mobile application may provide or display a capture window or outline and provide an indication of when the mobile application detects or recognizes the desired product identifier, such as for the user to capture an image or video of the product identifier. For example, the user may position the camera of a smart phone as to put the barcode of a product in the capture window or outline. Upon being positioned within the capture window, the mobile application may give an indication to capture the image and the user may select a user interface element to capture the image. The mobile application may store the image in memory or storage until the user sends the image to the stomp server.

Referring to FIG. 5B, an embodiment of a mobile application capturing a consumption or use of the product is depicted. The mobile application may be designed and constructed to prompt the user to capture a video or image of consumption, use or destruction of the product. The mobile application may provide or display a prompt to the user of what one or more actions may be taken to meet the requirements or guidelines for verification. In some embodiments, responsive to the user indicating they are taking or took the action and/or the mobile application detecting the same, the mobile application may give an indication to capture the image and the user may select a user interface element to capture the image. In some embodiments, the user may take a video of the user taking the action of consumption, user or destruction of the product. The mobile application may store the video and/or image in memory or storage until the user sends the image to the stomp server.

Upon capturing in media identification of the product and an act of consumption, use or destruction of the product, the mobile application may send one or more media files to the stomp server for verification. In some embodiments, the mobile application sends one media file comprising both the product identification and product consumption media. In some embodiments, the mobile application sends the product consumption media separately but in association with the product consumption media. If any of the media is not processable by the stomp server or the stomp server may not be able to identify the product and/or consumption of the product based on the quality of the media or the capture, the stomp server may provide an indication to the mobile application regarding the same. The mobile application may allow the user to recapture the media and resubmit for processing to the stomp server. The mobile application may receive from the stomp server and/or loyalty server information and notices on participating in a loyalty program and promotions, rewards earned and status and redemption of such loyalty programs promotions and rewards.

What is claimed:

1. A method for verifying consumer consumption of a product, the method comprising:
receiving, by a server, a media file from a device of a consumer, the media file comprising a representation of a product and a representation of the product being consumed;
identifying, via the server, the product from the representation of the product in the media file;
verifying, via the server, that the product has been consumed from the representation of the product being consumed in the media file; and
providing, by the server, a product identifier and verification data associated with the consumer.

2. The method of claim 1, wherein identifying the product from the representation of the product further comprises determining if the representation of the product in the media file includes one or more features of the product that uniquely identifies the product.

3. The method of claim 1, wherein verifying the product is consumed further comprises determining that the representation of the product being consumed in the media file includes one or more features that uniquely identify an act of consumption of the product.

4. The method of claim 1, wherein the media file comprises one of an image, a video or an audio file.

5. The method of claim 1, further comprising receiving, by the server, at least one of a location identifier or a timestamp in association with the media file.

6. The method of claim 1, wherein the representation of a product comprises at least one of a barcode, a product logo, a product name, a international standard book number, an universal product code, or a European article number.

7. The method of claim 1, wherein the representation of the product being consumed comprises at least one of the product being opened, unwrapped, cut, crushed, marked with a writing instrument or a portion of the product crossed out with the writing instrument.

8. The method of claim 1, wherein identifying the product further includes comparing the representation of the product in the media file to a stored representation of the product on the server.

9. The method of claim 1, further comprising using, by the server, a computer vision system on the media file to one of identify the product from the representation of the product or verify that the product has been consumed from the representation of the product being consumed.

10. The method of claim 1, further comprising receiving, by the server responsive to a user's inspection of the media file, identification of the product from the representation of the product or a verification that the product has been consumed from the representation of the product being consumed.

11. The method of claim 1, wherein verifying the representation of the product being consumed is a unique instance further includes creating a unique fingerprint of the media file.

12. The method of claim 1, further comprising comparing the unique fingerprint of the media file to a plurality of previously stored fingerprints.

13. A system for verifying consumer consumption of a product, the system comprising:
a server configured to receive a media file from a device of a consumer, the media file comprising a representation of a product and a representation of the product being consumed; and
a verification engine configured to identify a product from the media file based on the representation of the product in the media file and verify that the product has been consumed from the representation of the product being consumed in the media file; and
wherein the server is configured to provide a product identifier and verification data associated with the consumer.

14. The system of claim 13, wherein the server is configured to determine if the representation of the product in the media file includes one or more features of the product that uniquely identifies the product.

15. The system of claim 13, wherein the server is configured to verify the product is consumed by determining that the representation of the product being consumed in the media file includes one or more features that uniquely identify an act of consumption of the product.

16. The system of claim 13, wherein the media file comprises one of an image, a video or an audio file.

17. The system of claim 13, wherein the server is configured to receive at least one of a location identifier or a timestamp in association with the media file.

18. The system of claim 13, wherein the representation of a product comprises at least one of a barcode, a product logo, a product name, a international standard book number, an universal product code, or a European article number.

19. The system of claim 13, wherein the representation of the product being consumed comprises at least one of the product being opened, unwrapped, cut, crushed, marked with a writing instrument or a portion of the product crossed out with the writing instrument.

20. The system of claim 13, wherein the server is configured to identify the product by comparing the representation of the product in the media file to a stored representation of the product on the server.

21. The system of claim 13, wherein the server is configured to use a computer vision system on the media file to one of identify the product from the representation of the product or verify that the product has been consumed from the representation of the product being consumed.

22. The system of claim 13, wherein the server is configured for a user to inspect the media file to one of identify the product from the representation of the product or verify that the product has been consumed from the representation of the product being consumed.

23. The system of claim 13, wherein the server is configured to create a unique fingerprint of the media file.

24. The system of claim 13, wherein the server is configured to compare the unique fingerprint of the media file to a plurality of previously stored fingerprints.
